(19) United States
(12) Patent Application Publication
(10) Pub. No.: US 2025/0334843 A1
(43) Pub. Date: Oct. 30, 2025

(54) BISTABLE FERROELECTRIC LIQUID CRYSTAL CELL

(71) Applicant: The Hong Kong University of Science and Technology, Hong Kong (CN)

(72) Inventors: Vigneshwaran SWAMINATHAN, Hong Kong (CN); Valerii VASHCHENKO, Hong Kong (CN); Abhishek Kumar SRIVASTAVA, Hong Kong (CN)

(21) Appl. No.: 19/188,052

(22) Filed: Apr. 24, 2025

Related U.S. Application Data
(60) Provisional application No. 63/637,896, filed on Apr. 24, 2024.

(51) Int. Cl. G02F 1/141; G02F 1/1337; G02F 1/1343; G02F 1/139

(52) U.S. Cl. CPC G02F 1/141; G02F 1/1337; G02F 1/134309; G02F 1/1391

(57) ABSTRACT

A bistable ferroelectric liquid crystal (FLC) cell includes a pair of substrates, conductor layers and alignment layers. A helix-free FLC layer is positioned between the alignment layers. The helix-free FLC layer has a molecular director representing an average molecular orientation of the helix free FLC layer and having two minimum energy states at molecular director alignments −θ and +θ corresponding to bistable state I and bistable state II. The first and second alignment layers have a mutually twisted alignment axis at a fixed angle that corresponds to the two minimum energy states of −θ and +θ such that application of an electric field switches the helix free FLC layer from bistable state I to bistable state II or from bistable state II to bistable state I.

### CROSS-REFERENCE TO RELATED APPLICATIONS

The present application claims priority from U.S. provisional patent application Ser. No. 63/637,896 filed Apr. 24, 2024, the disclosure of which is incorporated by reference herein.

### FIELD OF THE INVENTION

The present invention relates to ferroelectric liquid crystal cells and, more particularly, to ferroelectric liquid crystal cells with long-term bistability and high contrast ratios.

### BACKGROUND

Ferroelectric liquid crystals (FLCs) are a class of liquid crystalline materials that exhibit spontaneous electric polarization, which can be reoriented by an external electric field. Details of FLC materials, structures, and applications are found in Srivastava, A. K., Chigrinov, V. G., and Kwok, H. S. (2015) Ferroelectric liquid crystals: Excellent tool for modern displays and photonics. Jnl Soc Info Display, 23: 253-272. doi: 10.1002/jsid.370, Srivastava, Abhishek Kumar and Vashchenko, Valerii V . . . “3 Ferroelectric liquid crystals and their application in modern displays and photonic devices”. Unconventional Liquid Crystals and Their Applications, edited by Wei Lee and Sandeep Kumar, Berlin, Boston: De Gruyter, 2021, pp. 153-210. doi.org/10.1515/9783110584370-003, and Demus, D., Goodby, J., Gray, G. W., Spiess, H.-.-W., Vill, V., Dunmur, D. and Toriyama, K. (1998). Physical Properties: Optical Properties. In Handbook of Liquid Crystals (eds D. Demus, J. Goodby, G. W. Gray, H.-.-W. Spiess and V. Vill). doi.org/10.1002/9783527620760.ch7c, the disclosures of which is incorporated by reference herein.

Ferroelectric liquid crystals are typically found in the chiral smectic C phase, denoted as SmC*, which is a layered mesophase in which the rod-like molecules are tilted with respect to the layer normal and possess a microscopic chiral structure. In the SmC* phase, the molecular tilt direction rotates from one smectic layer to the next as a result of the intrinsic chirality of the material, leading to the formation of a macroscopic helical superstructure across the thickness of the cell. This helical superstructure has a well-defined pitch (p), which can range from hundreds of nanometers to hundreds of micrometers. The macroscopic helical structure, combined with the molecular tilt and chirality, leads to a macroscopic spontaneous polarization ranging from tens to hundreds of nanocoulombs per square centimeter.

The magnitude of the spontaneous polarization vector is determined by the molecular dipole moment and its orientation relative to the tilt plane, with the polarization lying perpendicular to the tilt direction. The molecular director of the FLC represents the average molecular orientation of each FLC layer.

Depending on the physical configuration of the device, the helical structure of the SmC* phase may either be preserved, deformed, or temporarily suppressed.

In ferroelectric liquid crystals that preserve the natural helical structure of the SmC* phase, the molecular director undergoes a continuous azimuthal rotation from one smectic layer to the next, forming a helically twisted configuration across the cell. The pitch of this helix, which is the distance over which the director completes a full 360-degree rotation, is typically on the order of several microns, depending on the material composition and temperature. In such systems, the spontaneous polarization vectors are distributed tangentially along the helix, effectively canceling each other out on a macroscopic scale and resulting in little to no net polarization in the absence of an external field.

When an electric field is applied perpendicular to the smectic layers, it induces a distortion or partial unwinding of the helix, leading to a net polarization and an associated optical change. This response is typically continuous and analog in nature, rather than fully bistable, as the helical structure seeks to reform once the field is removed. While this configuration allows for smooth modulation of optical properties, it generally does not support long-term memory or state retention, as the field-induced alignment relaxes back toward the original helical configuration due to elastic restoring forces within the liquid crystal material. This is a nominally bistable system.

Surface-stabilized ferroelectric liquid crystal cells (SSFLC) are configurations in which the natural helical pitch is somewhat eliminated, typically through a combination of strong surface anchoring provided by alignment layers and thin cell confinement in which the cell thickness is smaller than the natural helix pitch. This suppression of the helix results in a uniform director configuration across the cell and enables more rapid, “nominally bistable” electro-optical switching in response to an applied electric field. However, this form of nominal bistability is not sufficient for practical applications. In practice, the SSFLC devices fail to maintain the induced state over time as the natural helix reforms following field removal and the system may revert to an intermediate or partially helical state, leading to decay of the optical contrast and eventual loss of the stored polarization state. This decay can be on the order of minutes. Therefore, these systems do not exhibit true bistability. They are also nominally bistable systems.

In another nominally bistable variant, electrically suppressed helix (ESH) ferroelectric liquid crystals exhibit a helical structure under low field conditions, but this helix can be unwound when a sufficiently strong electric field is applied. This mechanism allows for reversible control of the optical state and free from defects compared to SSFLC However, the helix reforms following removal of the field, thus the material does not exhibit true bistability.

A third category, known as deformed helix ferroelectric liquid crystals (DHFLCs), retains a tightly wound helical structure with a sub-wavelength pitch, such that the helix is not optically resolvable. In DHFLCs, the helical arrangement is not eliminated but is deformed by the application of an electric field, leading to continuous modulation of optical properties. This enables analog phase modulation or fast optical shuttering without discrete switching between bistable states. Again, the helix reforms following the removal of the electrical field, and the material is not truly bistable.

In addition to the above problems, known FLC systems are often temperature dependent. That is, even their nominal bistability can be diminished or destroyed at elevated temperatures. Nominal bistability may also not be sufficient for low applied electrical pulse widths.

Each of these FLC material types offers distinct electro-optical behavior and supports a different set of applications, but none exhibit true bistability.

Thus, there is a need in the art for liquid crystal cells that exhibit true long-term bistability that can be used in practical device applications. The present invention addresses this need.

### SUMMARY OF THE INVENTION

The present invention provides a ferroelectric liquid crystal (FLC) cell that creates structural and energetic conditions such that the FLC cell maintains a selected polarization state indefinitely after removal of an applied electric field. In this truly bistable configuration, the cell architecture creates two deep and stable energy minima corresponding to the two polarization states, such that the liquid crystal molecules remain locked in the chosen configuration unless actively switched by an applied field.

In one embodiment, a helix-free ferroelectric liquid crystal layer is positioned between a pair of planar alignment layers formed on electrode layers. The alignment layers are twisted with respect to one another. The twisted alignment directions of the two layers are formed at a fixed angle, typically between 0 and 80 degrees, thereby inducing a continuous twist in the director profile of the liquid crystal layer. The competition between the surface anchoring of the twisted alignment layers and the electrostatic torque on the spontaneous polarization gives rise to two distinct molecular configurations, each corresponding to a local minimum in the free energy landscape of the system. When an electric field is applied, the polarization vector reorients along the direction of the field, selecting one of the two energy minima. After the field is removed, the molecular alignment remains in the selected state due to the elastic and surface anchoring forces, and no significant relaxation occurs. As a result, the device exhibits long-term retention of the optical and polarization state, even in the absence of any applied field, thereby achieving true bistability.

In one aspect, the present invention provides a bistable ferroelectric liquid crystal (FLC) cell including an upper component having an upper substrate and a first transparent current conducting layer disposed on the upper substrate. A first alignment layer is disposed on the first transparent current conducting layer. A lower component includes a lower substrate and a second current conducting layer disposed on the bottom substrate. A second alignment layer is disposed on the second current conducting layer. A helix-free FLC layer is positioned between the first alignment layer and the second alignment layer. The helix-free FLC layer has a molecular director representing an average molecular orientation of the helix free FLC layer and having two minimum energy states at molecular director alignments −θ and +θ corresponding to bistable state I and bistable state II. The first and second alignment layers have a mutually twisted alignment axis at a fixed angle that corresponds to the two minimum energy states of −θ and +θ such that application of an electric field switches the helix free FLC layer from bistable state I to bistable state II or from bistable state II to bistable state I.

The bistable FLC cell lower substrate may be a non-transparent substrate patterned with pixel-level electrode structures.

The pixel-level electrode structures may include thin-film transistors, CMOS logic circuits, or reflective micro-mirrors,

The lower substrate may be a silicon substrate.

A ferroelectric liquid crystal on silicon (FLCoS) display, optical phase modulator, optical filter, or tunable diffraction grating may include the bistable ferroelectric liquid crystal cells described.

The bistable ferroelectric liquid crystal (FLC) cell may be bistable at a temperature of 90° C. or lower.

The bistable ferroelectric liquid crystal (FLC) cell may be bistable in the visible light spectrum.

The bistable ferroelectric liquid crystal (FLC) cell may be bistable in optical communication bands O, E, S, C, L, and U.

The bistable ferroelectric liquid crystal (FLC) cell of claim 2, may have ferroelectric liquid crystal material that has been subjected to electric field training to initialize bistability.

In a further aspect, the present invention provides a ferroelectric liquid crystal (FLC) cell including an upper component having an upper substrate and a first transparent current conducting layer disposed on the upper substrate. A first alignment layer is disposed on the first transparent current conducting layer. A lower component includes a lower substrate and a second current conducting layer disposed on the bottom substrate. A second alignment layer is disposed on the second current conducting layer. A ferroelectric crystal layer is positioned between the first alignment layer and the second alignment layer. The FLC layer has a molecular director representing an average molecular orientation of the FLC layer and having two minimum energy states at molecular director alignments −θ and +θ and having a pitch p. The first and second alignment layers have a mutually twisted alignment axis at a fixed angle that corresponds to the two minimum energy states of −θ and +θ. When d is a distance between the upper component and the lower component of the cell, the cell is formed such that d>>p or d≈p.

### BRIEF DESCRIPTION OF THE DRAWINGS

FIG. 1 schematically depicts the structure of the ferroelectric liquid crystal cell of the present invention.

FIG. 2 illustrates the top view of the ferroelectric liquid crystal, showing the fixed angle of the mutually twisted alignment axis denoted as a.

FIG. 3 schematically and graphically depicts minimum bistable energy states.

FIG. 4 is a graph showing the bi-stability of the ferroelectric liquid crystal cell of the present invention in terms of its normalized transmittance over time, under conditions as explained in details in the Examples below.

FIG. 5 is a graph showing the bi-stability of the ferroelectric liquid crystal cell of the present invention when driven by sporadic rectangular waveforms.

FIG. 6 is a graph showing the bi-stability of the ferroelectric liquid crystal cell of the present invention when driven by sporadic rectangular waveforms, with the waveform patterns opposite to those in FIG. 4.

FIG. 7 is a graph showing the bi-stability of the ferroelectric liquid crystal cell of the present invention when driven by continuous rectangular waveforms.

FIG. 8 is a graph showing the response time of the ferroelectric liquid crystal cell of the present invention.

FIG. 9 illustrates an exemplary application of the ferroelectric liquid crystal cell in WDM technology.

### DETAILED DESCRIPTION

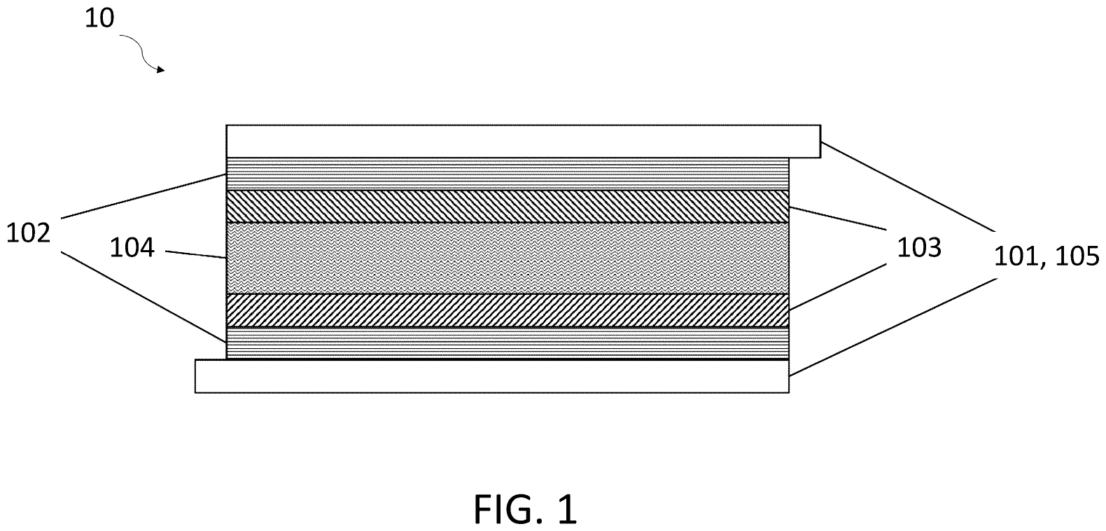

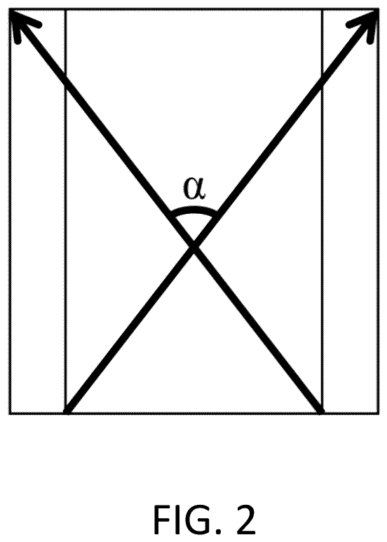

Turning to the drawings in detail, FIG. 1 schematically depicts a truly bistable ferroelectric liquid crystal device according to a first aspect of the present invention. In FIG. 1, cell 10 comprises two substrates 101, 105 respectively situated at the top and at the bottom, both coated with a current conducting layer 102 and alignment layers 103 and 103′. A helix-free ferroelectric crystal layer 104 is positioned between the alignment layers. The alignment axes of layers 103 are mutually twisted at a fixed angle α, as shown in FIG. 2. Application of an electric field across cell 10, causes switching between two truly bistable states.

“True” bistability refers to a device structure where a liquid crystal material remains in the selected state even after removal of the electric field, with no significant relaxation or reversion over time. In a truly bistable liquid crystal cell, the energy landscape of the device supports two discrete, deep energy minima, such that the system “locks” into either of the two truly bistable states. The system thus requires an external input (e.g., electric field) to switch to the other truly bistable state.

Further, in the context of the present invention, true bistability also requires the following additional conditions. These conditions are necessary for FLCs to exhibit truly bistable behavior of a sufficient duration and quality for practical applications. These conditions include: i) low operating or threshold voltage (on the order of single-digit volts per micron), ii) temperature-independent bistability, iii) fast response time (on the order of 10 to 100 microseconds), iv) long-term stability, and v) high contrast.

The term “bistable,” as used hereinafter, refers to systems that exhibit the above properties, as in the present invention; the expression “nominally bistable” refers to systems which do not exhibit the above properties.

The liquid crystal cell of FIG. 1 exhibits bistability according to the above criteria. That is, the molecules of the ferroelectric liquid crystal material settle into one of two minimum free energy configurations, depending on the field direction. In cell 10, helix-free ferroelectric liquid crystal layer 104 is positioned planar alignment layers 103 and 103′, each imparting a fixed alignment direction to the ferroelectric liquid crystal molecules. Since the alignment directions of layer 103 and 103′ are mutually twisted, a selected fixed twist angle ranging from 0 to 80 degrees is formed across the cell thickness. This geometrical configuration in cell 10 induces a continuous twist in the director profile n of the FLC layer, even in the absence of an applied field. Due to the ferroelectric nature of the material, the liquid crystal molecules exhibit a spontaneous polarization that is perpendicular to the tilt plane. When an electric field is applied across the cell, the spontaneous polarization reorients along the field direction, selecting one of two energetically favorable molecular configurations. Upon removal of the field, the molecular alignment remains stable without relaxation, as the system resides in a local minimum of the free energy landscape established by the competing elastic torque from the twisted alignment and the dipolar interaction of the FLC layer.

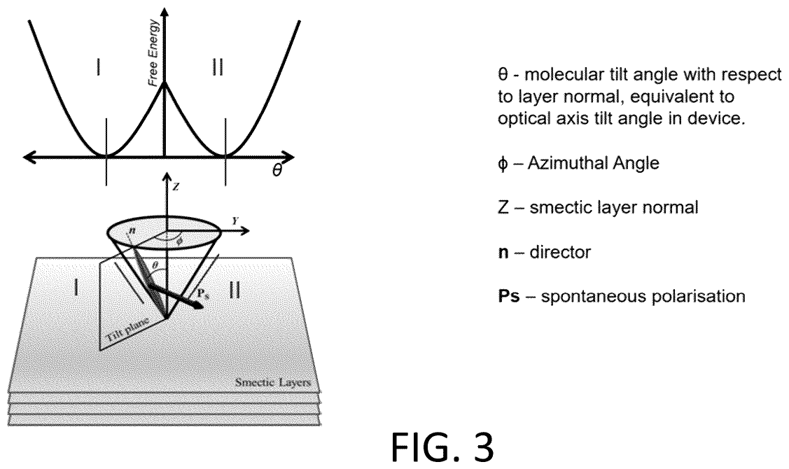

This is schematically illustrated in FIG. 3. In FIG. 3, there are two minimum free energy states, state I and state II. This is depicted in the free energy graph where a minimum free energy exists at two molecular tilt angles, +/−θ with respect to the layer normal z. Upon application of the electric field, the layer director, n, aligns to either +/−θ; in FIG. 3, the director is aligned to −θ, state I. After the electric field is removed, the mutually twisted alignment layers cause the FLC to retain its induced molecular tilt due to elastic and surface anchoring forces. Consequently, the device does not rely on the continued presence of the electric field or any other refreshing mechanism to maintain its state. Application of the opposite electric field causes the cell to switch from state I, where the director is aligned at −θ, to state II where the director is aligned at +θ.

In cell 10, the twisted structure of layers 103, effectively matches the two minimum energy states of layer 104, resulting in bistability. For example, if ferroelectric crystal layer 104 has −30° and +30° as its two stable states then the twist angle of layers 103 is approximately 60°. Note that small offsets between the stable state angles and the twist angle still produce bistability.

The ferroelectric liquid crystal cell 10 is characterized by the ratio between its cell gap (d), that is, the distance between the coated substrates 101, 105 and the helix pitch (p), which ranges from 100 to almost 0. The ratio between cell gap d and helix pitch p creates important distinctions among different classes of materials for layer 104, discussed in detail below.

Various materials and configurations may be used for the construction of ferroelectric liquid crystal cell 10 depending upon the selected device application of cell 10.

Upper substrate 101 serves as a mechanical support for the cell and is transparent to allow light to pass through the cell in transmissive or reflective modes. The material may be selected from glasses such as borosilicate glass, soda-lime glass, or quartz. Plastics such as polyethylene terephthalate (PET), polycarbonate (PC), or triacetyl cellulose (TAC) may also be used.

The conductive layer 102 for upper substrate 101 is a transparent conductive layer such as indium tin oxide (ITO) fluorine-doped tin oxide (FTO) graphene, or silver nanowires. The conductive layers may be patterned using photolithographic or printing techniques to define electrode regions.

The alignment layers may be selected from polyimides, nylon, polyvinyl alcohol. These alignment layers are typically aligned by uniaxial physical rubbing. The alignment layer may also be a phosphonic acid-based self-assembled single molecular layer.

Alternatively, a photoalignment dye system may be used for alignment layers 103, 103′. For example, azo-dye derivatives may be used for alignment layer as it permits non-contact alignment using polarized UV light. Advantageously, this permits patterning with highly-developed UV-based patterning tools.

The second substrate 105 may be either transparent or reflective, based on the device to be formed. Advantageously, a non-transparent substrate such as a silicon wafer may be used as second substrate 105. This silicon substrate may be patterned with pixel-level electrode structures, such as thin-film transistors (TFTs), CMOS logic circuits, or reflective micro-mirrors, depending on the intended application. The silicon substrate typically includes an insulating/passivating layer, such as silicon dioxide (SiO₂) or silicon nitride, over which conductive layer 102′ (e.g., aluminum, polysilicon, or indium tin oxide) are deposited and patterned to define pixel electrodes. These electrodes are then covered with the alignment layer 103′.

In reflective configurations, the silicon substrate acts as a reflective backplane, optionally incorporating a reflective metal layer (such as aluminum) beneath the pixel electrodes. In this case, incident light enters through the transparent upper substrate 101, interacts with the FLC layer, and reflects off the silicon-based pixel electrode backplane before exiting through the same transparent path.

By integrating the driving electronics directly onto the silicon substrate, precise electric fields can be applied across each FLC pixel, enabling fast, low-voltage modulation of the optical state.

These electronic structures may be used to create individually addressable FLC elements in applications such as ferroelectric liquid crystal on silicon (FLCoS) displays, optical phase modulators, or tunable diffraction gratings (e.g., for WDM). In WDM systems, the FLC cells can be used for dynamic add/drop multiplexing, optical signal routing (e.g., demultiplexing), and tunable optical filters.

To form the complete FLC cell 10, coated substrates 101 and 105 are assembled facing one another. The cells are aligned with precise and uniform gaps by the use of spacers selected from glass microbeads, polymer microbeads, photo-patterned polymer spacers or post spacers, which provide micron to sub-micron level levels of spacing precision. The FLC material fills the uniform gap between the coated substrates from the spacers, assisted by capillary action.

In the present invention, a helix-free ferroelectric liquid crystal material 104 may be formed through molecular engineering. However, the liquid crystal cells of the present invention may employ any helix-free liquid crystal material, regardless of a particular composition or technique used to achieve the helix-free state.

In one exemplary group of helix-free FLC materials, mixtures of ferroelectric liquid crystals are created that include mixtures of chiral dopants that induce the helix of opposite sign but do the same sign of spontaneous polarization, matched with respect to their helical twisting power to compensate for the helix thereby achieving an infinitely helix-free FLC.

The chiral compounds of FLC liquid crystals for layer 104 are selected and mixed according to the equation below:

$${\sum }_{i} {HTP}_{i} \times {c}_{i} = 0$$

where cᵢ corresponds to the concentration of each chiral compound, and HTPᵢ corresponds to the helical twisting power of the particular chiral compound.

While numerous combinations of ferroelectric liquid crystals may be combined according to the above formula, the following chiral compounds are examples of those which can be used for helix compensation in a FLC used in the present invention:

| | Sign of | Sign of |
|---|---|---|
| | spontaneous | helical |
| Structure of chiral compound | polarization | twisting |
| 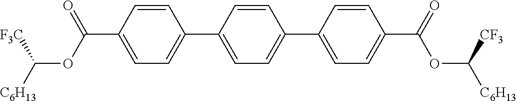 | − | − |
| 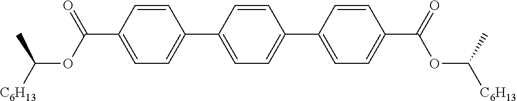 | − | + |
| 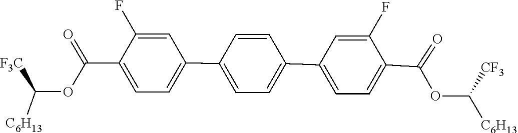 | − | − |
| 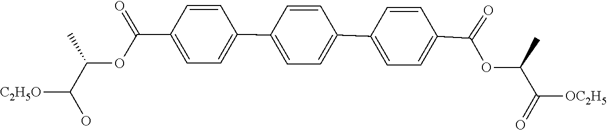 | − | + |

The overall selection of the particular ferroelectric crystals, however, may differ according to the cell gap-helix pitch ratio as described in detail in the Examples section, below, which provide detailed compositions used to fabricate FLC cells and the performances of exemplary ferroelectric liquid crystal cells constructed.

### EXAMPLES

### 1. FLC Compositions

Example compositions are given below according to FLC cell parameters cell gap (d) and helix pitch (p). In the first case, the helix pitch of the ferroelectric liquid crystal is infinitely long (i.e. when d<p and the d:p ratio tends to 0) creating bistable FLC cells. Exemplary mixtures are set forth in Table 1 below.

TABLE 1
Compositions of FLC mixtures when d<<p (Bistable FLC cell)

| | Concentration, wt. % | |
|---|---|---|
| | Composition | Composition |
| Compounds | No. 09-243 | No. 11-122 |
| 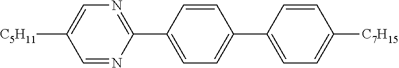 | 12.0 | 9.4 |
| 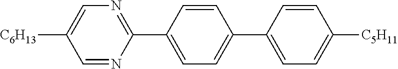 | 26.6 | 20.5 |
| 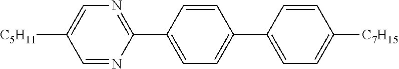 | 12.3 | 9.5 |
| 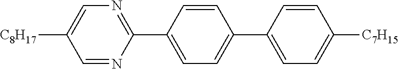 | 20.5 | 13.9 |
| 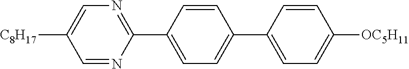 | — | 9.3 |
| 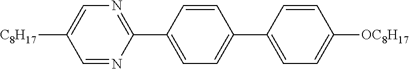 | — | 10.1 |
| 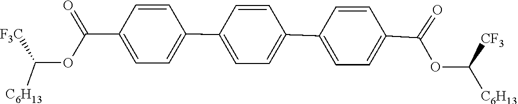 | 10.3 | — |
| 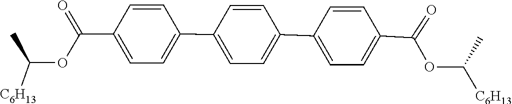 | 18.3 | — |
| 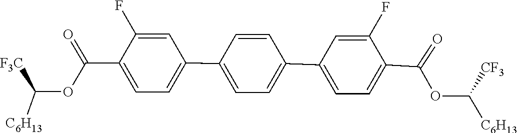 | — | 11.8 |
| 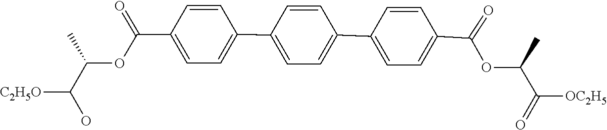 | — | 15.4 |

In another aspect, the present invention provides improved properties to electrically-suppressed (ESH) ferroelectric liquid crystals and deformed helix ferroelectric liquid crystals (DHFLC).

For example, in cases where the cell gap and helix pitch of the FLC are relatively similar (d≈p), i.e. the d:p ratio tends to 1. These ferroelectric liquid crystals are electrically suppressed helix ferroelectric liquid crystals (ESH FLC). They may be used as layer 104 and produce nominally bistable cells. Examples of such FLC mixtures are given in Table 2 below.

TABLE 2
Compositions of FLCs mixtures when d≈p (Nominally Bistable ESH cell)

| | Concentration, wt. % | |
|---|---|---|
| | Composition | Composition |
| Chiral compounds | No. 595 | No. 11-044 |
| 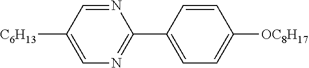 | 33 | 20.9 |
| 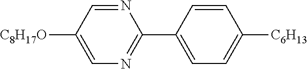 | 21.9 | 13.9 |
| 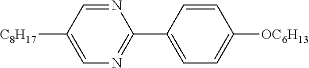 | 21.9 | 13.9 |
| 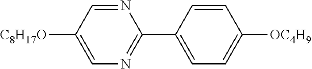 | — | 7.6 |
| 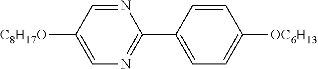 | — | 7.7 |
| 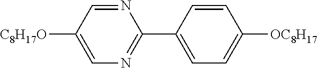 | — | 3.8 |
| 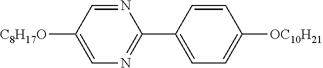 | 7 | 11.9 |
| 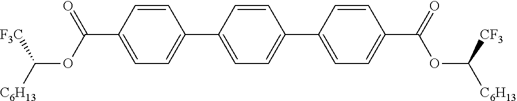 | 16.2 | — |
| 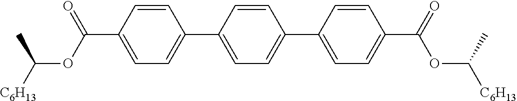 | — | 20.2 |

When the helix pitch is smaller than the cell gap (d>p), i.e. the d:p ratio rises over 1, the ferroelectric liquid crystals are deformed helix ferroelectric liquid crystals (DHFLC). Examples of DHFLC mixtures are given in Table 3 below.

TABLE 3
Compositions of FLCs mixtures when d>>p (Nominally Bistable DHFLC
cell).

| | Concentration, wt. % | |
|---|---|---|
| | Composition | Composition |
| Chiral compounds | No. 587 | No. 9-196 |
| 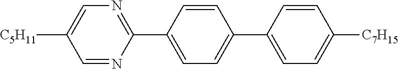 | — | 10.7 |
| 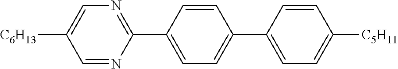 | 47 | 23.9 |
| 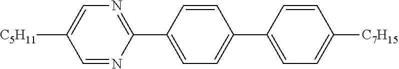 | — | 11.0 |
| 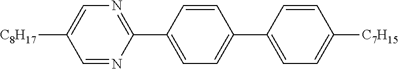 | 19 | 18.4 |
| 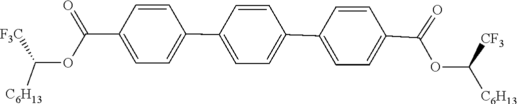 | 34 | — |
| 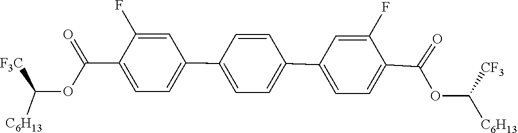 | — | 36.0 |

### Example 1: Fabrication of Ferroelectric Liquid Crystal Cells

An exemplary ferroelectric liquid crystal (FLC) cell is formed according to the structure depicted in FIG. 1. The FLC cell consists of two glass substrates, each coated with a transparent electrical current conducting indium-tin oxide (ITO) layer. Each ITO-coated substrate is spin coated with an alignment layer of azo-dye mixed in dimethylformamide (DMF).

The spin-coated substrates undergo a soft baking process to allow for solvent evaporation. Subsequently, the substrates are exposed to polarized UV light, which photoaligns the azo-dye (SD1). This step ensures the precise alignment of the ferroelectric liquid crystal molecules.

Next, the two substrates are carefully positioned on top of each other, maintaining a fixed gap between them using microbead spacers. This arrangement precisely establishes the desired cell thickness and thickness uniformity along the entire cell. After the substrate assembly, the selected FLCs are introduced into the cell. This is achieved through the utilization of capillary action, allowing the ferroelectric liquid crystals to fill the gap between the substrates.

The formed FLC cells were subjected to an initial electric field conditioning to facilitate the bistability effect. The electric field conditioning method enables the ferroelectric liquid crystal cell to achieve bi-stable electro-optic phenomenon display for a time period of at least 24 hours. A low-frequency electric field (for example, less than 50 Hz) at an intensity of at least 10 V/μm using a rectangular waveform with both polarities is applied to the cell. This effectively guides the molecule to its two stable positions.

### Example 2: Bi-Stability Performance of the Ferroelectric Liquid Crystal Cells

To test the long-term bi-stable electro-optic response of the FLC cell, a red laser with a wavelength of 633 nm serves as the light source. A rotating sample stage with heater control is positioned between a pair of Glan-Thompson polarizers set in a crossed state. Additionally, a high-speed detector is placed after the second polarizer to capture the sample's response.

To initiate the test, the long axis of the aligned FLC cell is initially set at a 45-degree angle, maximizing the transmission with the crossed polarizers. A short pulse of 1 ms duration, accompanied by an electric field of 1 volt per micrometer, is then applied. Subsequently, the test is repeated once more for test of opposite polarity.

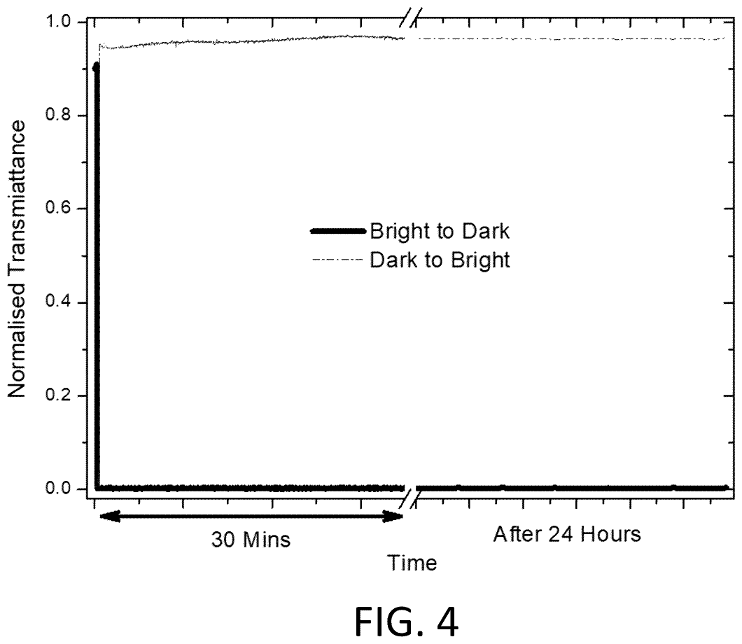

As observed in FIG. 4, upon the first electrical simulation, the FLC molecules switch to the opposite side of the cone, resulting in a dark state persisting for more than 24 hours. In the subsequent stimulation, the FLC cell transitions to the bright state, also persisting for more than 24 hours, exemplifying its long-term electro-optic bistability.

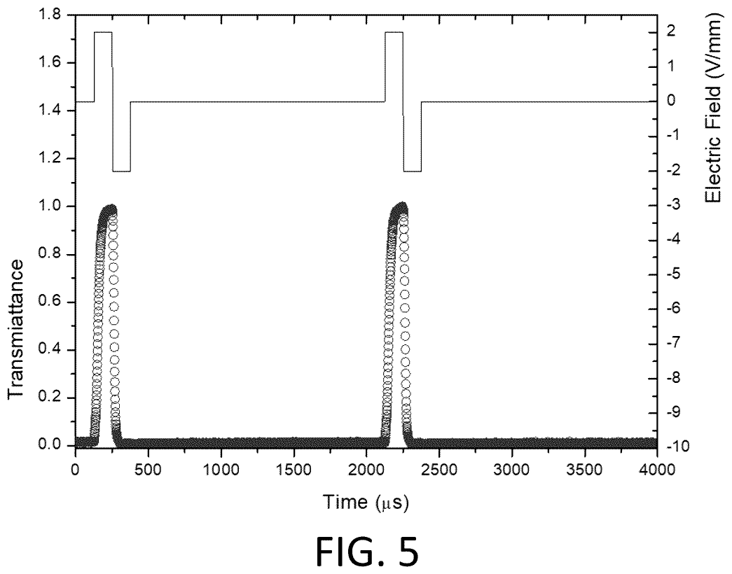

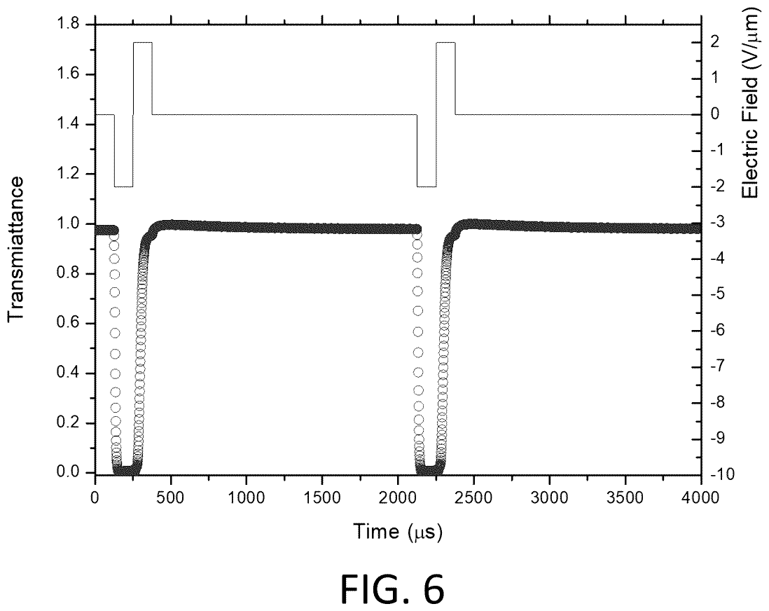

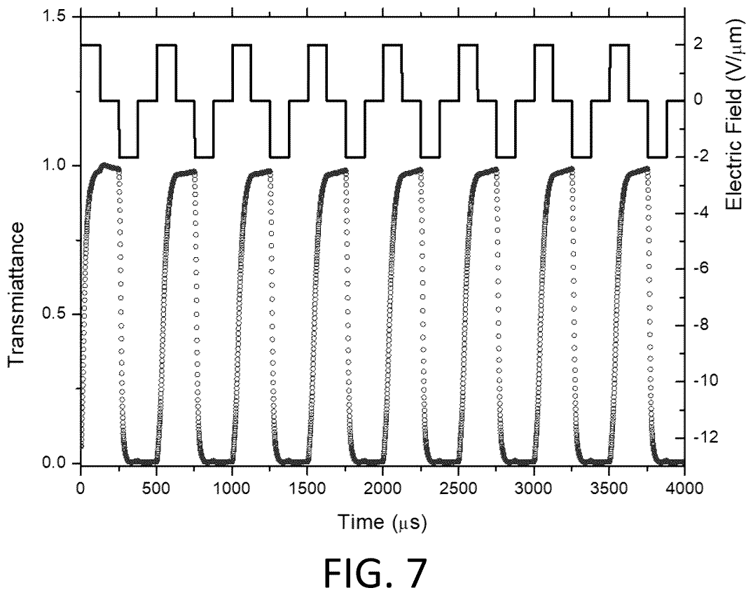

The test is repeated with the FLC cell driven by an electrical field with (i) sporadic rectangular waveforms; (ii) sporadic rectangular waveforms but of opposite shapes to the ones used in (i); and (iii) continuous rectangular waveforms. The results, as shown in FIGS. 5, 6 and 7 respectively demonstrate the bi-stability of the FLC cell.

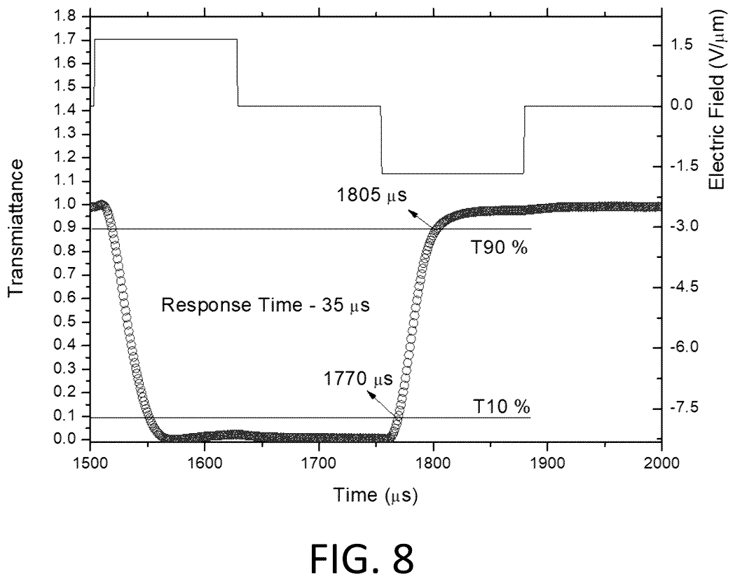

Further, the response time of the FLC cell is also investigated and shown in FIG. 8. It is observed that the response time is well within tens of microseconds.

### Example 3—Application of the Ferroelectric Liquid Crystal Cells

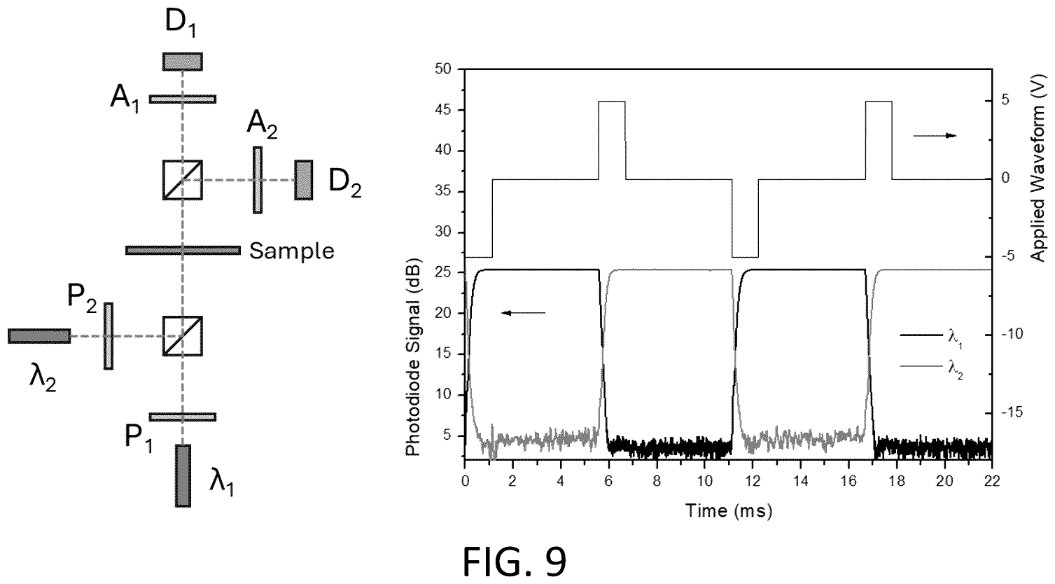

The ferroelectric liquid crystal cells is integrated into an optical filter for in the wavelength division multiplexed (WDM) systems for fiber-optic communications. One compelling application is their use as a reconfigurable Bragg grating, which can be dynamically tuned to reflect or transmit specific optical wavelengths depending on the orientation of the FLC molecules In FIG. 9, the FLC cell an exemplary setup of which is illustrated in FIG. 9. In FIG. 9 2×2 wavelength division multiplexer based on polarization rotator switch using helix-free Ferroelectric Liquid Crystal with twisted alignment.

Several embodiments of the present disclosure and features of details are briefly described above. The embodiments described in the present disclosure may be easily used as a basis for designing or modifying other processes and structures for realizing the same or similar objectives and/or obtaining the same or similar advantages introduced in the embodiments of the present disclosure. Such equivalent construction does not depart from the spirit and scope of the present disclosure, and various variations, replacements, and modifications can be made without departing from the spirit and scope of the present disclosure.

As used herein, the terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

1. A bistable ferroelectric liquid crystal (FLC) cell comprising:
an upper component comprising:
an upper substrate;
a first transparent current conducting layer disposed on the upper substrate; and
a first alignment layer disposed on the first transparent current conducting layer;
a lower component comprising:
a lower substrate;
a second current conducting layer disposed on the bottom substrate; and
a second alignment layer disposed on the second current conducting layer; and
a helix-free FLC layer positioned between the first alignment layer and the second alignment layer, the helix-free FLC layer having a molecular director representing an average molecular orientation of the helix free FLC layer and having two minimum energy states at molecular director alignments −θ and +θ corresponding to bistable state I and bistable state II; and
the first and second alignment layers have a mutually twisted alignment axis at a fixed angle that corresponds to the two minimum energy states of −θ and +θ such that application of an electric field switches the helix free FLC layer from bistable state I to bistable state II or from bistable state II to bistable state I.

2. The bistable ferroelectric liquid crystal (FLC) cell of claim 1, wherein the lower substrate is a non-transparent substrate patterned with pixel-level electrode structures.

3. The bistable ferroelectric liquid crystal (FLC) cell of claim 2, wherein the pixel-level electrode structures include thin-film transistors, CMOS logic circuits, or reflective micro-mirrors.

4. The bistable ferroelectric liquid crystal (FLC) cell of claim 2, wherein the lower substrate is a silicon substrate.

5. A ferroelectric liquid crystal on silicon (FLCoS) display, optical phase modulator, optical filter, or tunable diffraction grating including the bistable ferroelectric liquid crystal (FLC) cell of claim 2.

6. The bistable ferroelectric liquid crystal (FLC) cell of claim 2, wherein the bistable ferroelectric liquid crystal material is bistable at a temperature of 90° C. or lower.

7. The bistable ferroelectric liquid crystal (FLC) cell of claim 2, wherein the bistable ferroelectric liquid crystal material is bistable in visible light spectrum.

8. The bistable ferroelectric liquid crystal (FLC) cell of claim 2, wherein the bistable ferroelectric liquid crystal material is bistable in optical communication bands O, E, S, C, L, and U.

9. The bistable ferroelectric liquid crystal (FLC) cell of claim 2, wherein the bistable ferroelectric liquid crystal material has been subjected to electric field training to initialize bistability.

10. A ferroelectric liquid crystal (FLC) cell comprising:
an upper component comprising:
an upper substrate;
a first transparent current conducting layer disposed on the upper substrate; and
a first alignment layer disposed on the first transparent current conducting layer;
a lower component comprising:
a lower substrate;
a second current conducting layer disposed on the bottom substrate; and
a second alignment layer disposed on the second current conducting layer; and
a ferroelectric liquid crystal (FLC) layer positioned between the first alignment layer and the second alignment layer, the FLC layer having a molecular director representing an average molecular orientation of the FLC layer and having two minimum energy states at molecular director alignments −θ and +θ and having a pitch p; and
the first and second alignment layers have a mutually twisted alignment axis at a fixed angle that corresponds to the two minimum energy states of −θ and +0; and
wherein d is a distance between the upper component and the lower component of the cell and the cell is formed such that d>>p or d≈p.
